(19) United States
(12) Patent Application Publication
(10) Pub. No.: US 2014/0372165 A1
(43) Pub. Date: Dec. 18, 2014

(54) FAST 4-DIMENSIONAL CONSTRUCTION SCHEDUEL SIMULATION SYSTEM BASED ON OBJECT BEHAVIORS

(71) Applicant: Industry-Academic Cooperation Foundation, Yonsei University, Seoul (KR)

(72) Inventors: GHANG LEE, Seoul (KR); Chi Yon Cho, Seoul (KR); Yong Hoon Choi, Seoul (KR)

(21) Appl. No.: 13/919,455

(22) Filed: Jun. 17, 2013

(51) Int. Cl. G06Q 50/08; G06Q 10/06

(52) U.S. Cl. CPC G06Q 50/08; G06Q 10/06313
USPC 705/7.23

(57) ABSTRACT

A fast 4D construction schedule simulation systems based on object behaviors according to the present invention may comprise an object library storage for storing object data, a behavior library storage for storing behaviors according to object types of the object data, an instance behavior value input section for inputting behavior values of an instance created from the object data to be modeled, a modeling section for modelling the instance using the object data, the behaviors and the behavior values and a display for displaying a behavior of the modeled instance.

### BACKGROUND OF THE INVENTION

1. Field of the Invention

The present invention relates to a simulation system for a construction schedule, and more particularly, to a 4-dimensional (4D) simulation system which simulates temporary structures, construction equipment, paths of flow of workers and so on, which are related to a schedule of a specific part of a building and civil facilities, within a short time.

2. Description of the Related Art

Recently, analysis methods based on computer simulation for a construction schedule have been widely worked. Nevertheless, the results of computer simulation, which are expressed numerically accompany with considerable difficulty to assure decision makers of construction projects. In order to overcome this problem, Cleveland et al. invented a 4D simulation technique which can visually simulate a construction schedule by associating it with a 3-dimensional (3D) model [Cleveland, A. B., Jr. (1937). “CAD, 3-D Modeling and Construction Management” Construction Specifier, 40(4), 78-83, 86-89].

This 4D simulation technique has been farther developed through many studies. However, a massive amount of time must be spent on the 4D modeling process, since schedules of objects in a 3D model, such as beams, columns, walls and so on, must be separately defined. In order to overcome this problem, attempts have been made to automate the 4D modeling technique. However, the application of these attempts is not practical, since they are applicable only in cases where special conditions are satisfied. In particular, it is difficult and time consuming to express temporary structures, excavated earth, a movement of equipment or workers, excavating work, and so on.

The information disclosed in the Background of the Invention section is provided only for the enhancement of understanding of the background of the invention, and should not be taken as an acknowledgment or any form of suggestion that this information forms a prior art that would already be known to a person skilled in the art.

### SUMMARY OF THE INVENTION

Accordingly, the present invention has been made keeping in mind the above problems occurring in the related art, and the present invention proposes a fast 4D construction schedule simulation system based on object behaviors, which is intended to realize the following objects.

First, an object is to provide an object-based simulation system in which behaviors that each object subjected to simulation can exhibit are defining in advance.

Second, an object is to provide a simulation system which defines the behaviors of each object as “show,” “hide,” “grow,” “translate,” “rotate” and other behaviors such that they can be intuitively recognised.

Third, an object is to provide a simulation system in which an object, the behavior of which is defined, can be added from an object library using a “drag and drop” function.

The objects of the invention are not limited to those mentioned above, and the other objects which have not been mentioned above will foe fully apparent to a person having ordinary skill in the art from the following description.

In an aspect of the present invention, provided is a fast 4D construction schedule simulation system based on object behaviors, which includes: an object library storage for storing object data; a behavior library storage for storing behaviors according to object types of the object data; an instance behavior value input section for inputting behavior values of an instance created from the object data to be modeled; a modeling section for modelling the instance using the object data, the behaviors and the behavior values; and a display for displaying a behavior of the modeled instance.

According to an exemplary embodiment of the present invention, object data stored in the object library storage are divided into worker group, equipment group, temporary structure group, material group, building element group, foundation group and miscellaneous groups, wherein the worker group includes workers, the equipment group includes a tower crane, a bulldozer, a truck, a backhoe and a borer, the temporary structure group includes scaffolding, a mold, a wheel washer, a temporary office and a fence, the material group includes reinforcing rods, earth, cement, wood and concrete beams, the building element group includes walls, stairs, beams, columns, doors, windows and building equipment, the foundation group includes a foundation, and the miscellaneous group includes furniture and sanitary equipment.

According to an exemplary embodiment of the present invention, behaviors stored in the behavior library storage include at least one behavior selected from the group consisting of show, hide, translate, rotate, group and grow.

According to an exemplary embodiment of the present invention, behaviors of the object data axe defined as in the following table.

| Object Group | Object Examples | Object Behaviors |
|---|---|---|
| Worker | Worker | Show, Hide, Translate, |
| | | Rotate, Group |
| Equipment | Tower crane | Show, Hide, Grow (Boom, |
| | | Mast, Cable), Divide, Rotate |
| | | (only boom post), Group |
| | Bulldozer, Truck | Show, Hide, Translate, |
| | | Rotate, Group |
| | Backhoe | Show, Hide, Translate, |
| | | Rotate (only upper part or |
| | | arm part is rotatable, or |
| | | entire parts are rotatable), |
| | | Group |
| | Borer | Show, Hide, Translate, |
| | | Rotate, Group |
| Temporary | Scaffolding, Mold, | Show, Hide, Translate, |
| structure | Wheel washer, | Rotate, Group, Grow, Divide |
| | Temporary office, | |
| | Fence | |
| Material | Reinforcing rod, | Snow, Hide, Translate, |
| | Earth, Cement, | Rotate, Group, Grow, Divide |
| | Wood, Concrete | |
| | beam | |
| Foundation | Foundation | Grow, Divide |
| Building | Wall, stair, Beam, | Show, Hide, Translate, |
| element | Column, Door, | Group, Rotate, |
| | Window, etc. | Grow, Divide |
| Miscellaneous | Furniture, | Show, Hide, Translate, |
| | Sanitary equipment | Group, Rotate |

According to an exemplary embodiment of the present intention, the behavior values of the instance includes at least one value selected from the group consisting of a position where a behavior starts, a position where the behavior ends, a number of repetitions of the behavior, a pace of the behavior and a 3-dimensional directional value of the behavior.

According to an exemplary embodiment of the present invention, the display may include an object displaying part for displaying icons of the objects according to the types;

a behavior displaying part for displaying behaviors of the objects; a schedule displaying part for displaying schedules linked to the objects; and a main displaying part for displaying a simulated 4-dimensional construction schedule.

According to an exemplary embodiment of the present invention, the object behavior input section receives the behavior values for the instance via the behavior displaying part.

According to an exemplary embodiment of the present invention, an instance simulated is added by dragging one object from among the objects displayed on the object displaying part and dropping the one object onto the main displaying part, and the main displaying part or the behavior displaying part sets behavior values of the added instance.

According to an exemplary embodiment of the present invention, the object behavior input section receives the behavior values for the instance via the behavior displaying part.

According to an exemplary embodiment of the present invention, an instance to be simulated is added by dragging one object from among the objects displayed on the object displaying part and dropping the one object onto the main displaying part, and the main displaying part or the behavior displaying part sets behavior values of the added instance.

According to an exemplary embodiment of the present invention, the schedule displaying part displays the schedules of the instances with times based on the behavior values of the instances.

According to an exemplary embodiment of the present invention, when at least one instance that is added is set to a group, the behavior values of the instances belonging to the group are commonly set based on one behavior value.

According to an exemplary embodiment of the present invention, an alarming section indicates conflicting instances and locations when two or more modeled instances interfere with each other during simulation.

The fast 4D construction schedule simulation system may further include an alarming section which indicates interfering instances and interfering points when two or more instances that are modeled interfere with each other during simulation.

According to embodiments of the invention, the fast 4D construction schedule simulation system based on object behaviors carries out a simulation on each object by defining behaviors in advance with respective objects and receiving input values required for actual behavior simulation.

In addition, the fast 4D construction schedule simulation system based on object behaviors according to the invention allows a user to create a simulation including temporary structures and equipment using a convenient interface. Furthermore, the fast 4D construction schedule simulation system based on object behaviors according to the invention allows for a simulation to be created at specific levels, so that a user can conveniently review the entire construction schedule and analyze problems if necessary.

The effects of the invention are not limited to those mentioned above, and the other effects which have not been mentioned above will be fully apparent to a person having ordinary skill in the art from the following description.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a block diagram showing the schematic configuration of a fast 4D construction schedule simulation system based on object behaviors according to the present invention;

FIG. 2 is an example of a classification table showing an object group, objects belonging to the object group and behaviors of each object according to the present invention;

FIG. 3 is shows an example of a simulation screen according to the present invention; and

FIG. 4A and FIG. 4B show partial magnifying views of the simulation screen shown in FIG. 3, in which FIG. 4A shows the object displaying part, and FIG. 4B shows the behavior displaying part.

### DETAILED DESCRIPTION OF THE INVENTION

Reference will now be made in detail to various embodiments of the present invention, examples of which are illustrated in the accompanying drawings and described below. While the invention will be described in conjunction, with exemplary embodiments thereof, it is to be understood, that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the invention as defined by the appended claims.

While terms such as “first,” “second,” “A” and “B” can be used in describing various elements, it should be understood that these terms do not limit those elements but merely discriminate those elements from others. For instance, first element can foe named the second element, and vice versa, without departing the scope of protection or the present invention. The term “and/or” shall include the combination of a plurality of listed items or any of the plurality of listed items.

Unless clearly used otherwise, some expressions in the singular number may include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, members, steps, operations, elements, parts or combinations thereof.

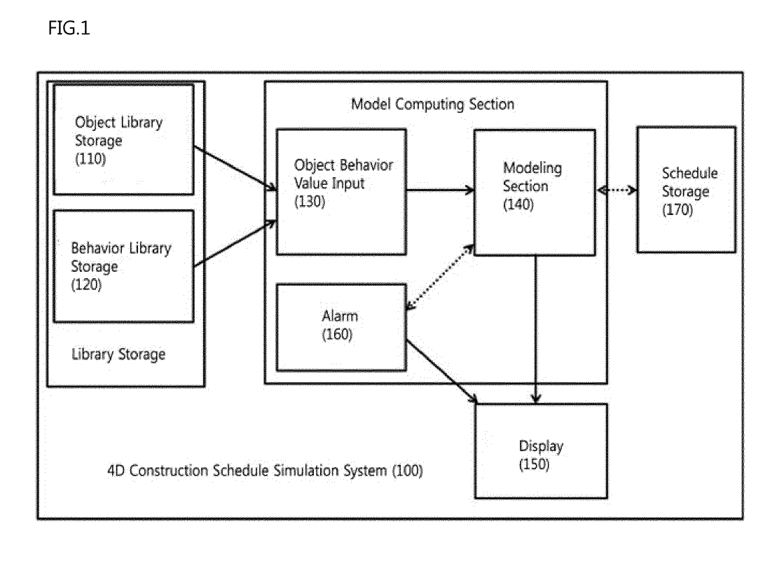

Before the present invention is described in detail with reference to the drawings, it should be understood that constituent elements of the present invention are merely distinguished according to their main functions. Specifically, two or more constituent elements that will be described later may be combined into one constituent element, or one constituent element may be divided into two or more constituent elements having more specified functions. Each constituent element that will be described later may additionally carry out some or all of the functions of another constituent element in addition to its main function, or some of the main functions of one constituent element may be carried out exclusively by another constituent element. Therefore, the presence of the constituent elements which will be described herein should foe interpreted based on their functions. The configuration of the constituent elements of a fast 4D construction schedule simulation system based on object behaviors 100 according to the invention may be different from FIG. 1 as long as they can realise the object of the present invention.

### DEFINITION OF TERMS

The technical terms used in the description of the present invention are technical terms that are generally used in the Construction IT (information technology) industry, and are defined as follows:

Object: The term “object” refers to anything that is endowed with a 3D physical shape related to the construction, such as beams, columns, walls, stairs, workers, equipment, temporary structures, earth or so on, in a 3D construction model.

Instance: The term “instance” refers to an object that is simulated on an actual simulation. Whenever an object icon is “dragged and dropped” on a display screen, an instance is created every time.

Behavior: Each object can perform a unique “behavior.” For example, a worker can perform a behavior of “walking.” A column can be “installed.” Equipment can “travel.”

Construction schedule or (simply) schedule: These terms refer to a sequence and a timetable of construction works.

4D simulation: This term refers to a technology for displaying the process of construction like a video image by linking schedule information to a 3D model.

4D modeling: This term refers to a process for defining schedule of the construction with respect to each object for 4D simulation.

Hereinafter, the fast 4D construction schedule simulation system based on object behaviors 100 will be described in detail with reference to the drawings.

FIG. 1 is a block diagram showing the schematic configuration of a fast 4D construction schedule simulation system based on object behaviors 100 according to the present invention.

The fast 4D construction schedule simulation system based on object behaviors 100 according to the present invention includes an object library storage 110 which stores object data according to object types; a behavior library storage 120 which stores therein behavior data according to the object types stored in the object library storage 110; an instance behavior value input section 130 into which behavior values with respect to an instance is inputted, the instance being created for an object, among objects, which is modeled on the simulation system; a modeling section 140 which models the instance using the object data, the behavior data and the behavior values; and a display 150 which displays the instance and a behavior of the instance modeled by the modeling section 140.

The 4D construction schedule simulation according to the invention is carried out basically by a graphic-based modeling program which operates on a computer. The objects stored in the object library storage 110 can be referred to as basic: units for the construction schedule. Equipment at a construction site, workers, structure units which are constructed by them, and so on, correspond to the basic units.

The objects stored in the object library storage 110 are divided into worker group, equipment group, temporary structure group, material, group, building element group, foundation group and miscellaneous groups.

The worker group includes workers, and the equipment group includes a tower crane, a bulldozer, a truck, a backhoe and a borer. The temporary structure group includes scaffolding, a mold, a wheel washer, a temporary office and a fence, and the material group includes reinforcing rods, earth, cement, wood and concrete beams. The building element group includes walls, stairs, beams, columns, doors, windows and building equipment, and the foundation group includes a foundation. In addition, the miscellaneous group includes furniture and sanitary equipment.

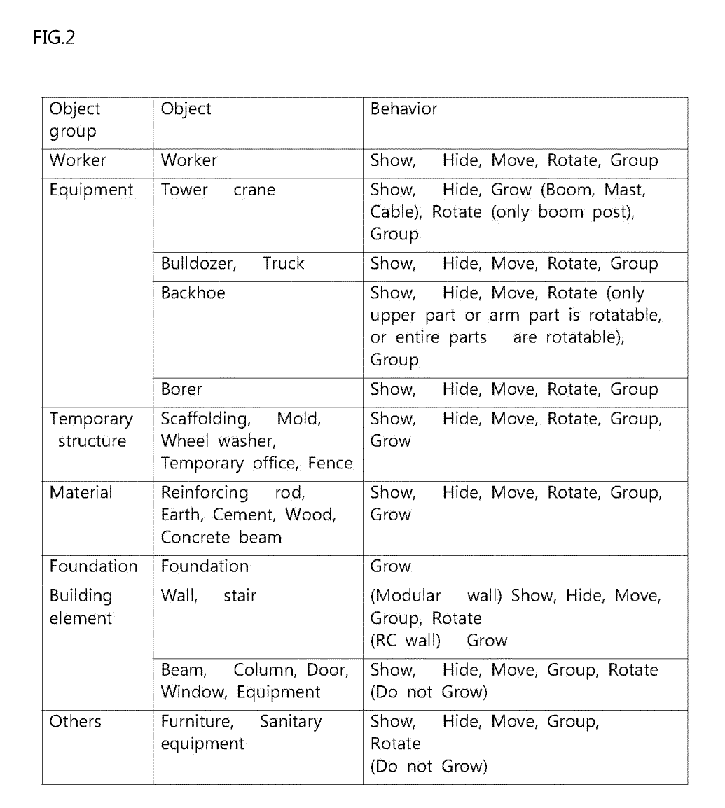

FIG. 2 is an example of a classification table showing an object group, objects belonging to the object group and behaviors of each object according to the invention.

The worker group refers to a person who carries out an operation at the construction site, and the equipment group refers to a crane, a bulldozer, a backhoe, a forklift, a borer, an excavator, a truck and so on, which generally move during a construction process. When the actual movement, includes rotation (pivoting), the corresponding object must be connected via a joint such that the rotation can be expressed and a physical collision can foe examined.

The temporary structure group refers to annexes which are not included in the final structure font are required in the middle of the construction schedule. The temporary structure group includes scaffolding, a mold, a wheel washer, a temporary office, a fence and so on.

The material group refers to materials used in the construction of a structure, and includes, for example, H shape steel, reinforcing rods, earth, cement, wood, concrete beams and so on.

The foundation refers to a foundation that is to be excavated or filled. In the 4D simulation system 100 according to the invention, when a start point and the direction are designated, it is possible to cause a predetermined volume (an amount of foundation to be excavated or filled) to disappear (be excavated) or appear (be filled) at a predetermined time.

The building element group refers to individual components which constitute the structure, such as walls, columns, stairs, beams, roofs, windows, doors, building equipment and so on.

The miscellaneous group includes the other components which are installed in the structure, such as furniture, sanitary equipment and so on.

The object library storage 110 stores therein data for all of the above-described objects necessary for simulation. The data are distinguished by the unique code for each object, and include information used to express each object in graphics.

The behavior library storage 120 stores therein information about a variety of behavior data carried out by the objects. Even though specific behaviors may differ according to the objects, the behavior basically include “Show,” “Hide,” “Translate,” “Rotate,” “Grow” and other behaviors. FIG. 2 shows an example of behaviors according to each object. The “Show and Hide behaviors” are similar to the function of a traditional 4D simulator. These behaviors cause an object to show and hide, and are presented as if a building is being gradually constructed or dismantled.

The “Grow behavior” is presented in a way in which a specific object changes with time. For example, in order to simulate an image of an excavating operation or an operation of pouring a concrete wall, the traditional 4D simulator must execute modeling by making an amount of work par unit time into one object and stacking such objects one by one like bricks. This approach has problems in that not only is a long modeling time required, but also modeling must foe executed again from the beginning when the amount of work per unit time is changed.

According to the present invention, it is possible to make a wall or earth to show or hide at a predetermined speed in a given time using the “Grow” behavior (function). It is possible to remove it in the reverse order. The direction of growth is indicated such that an object grows in that direction.

The “divide behavior” allows an object to be split into small pieces so that the object can be displayed piece by piece in sequence.

The “Translation (move) behavior” is set to repeatedly move along a path selected from among a straight line, a curve or a combination thereof for a predetermined time. Otherwise, when a translation start point is designated, a path finding algorithm causes an object to move to a site that is under construction along a passage or a path of flow. Since traditional simulators had no function of moving an object, it was complicated and difficult to express the Translate behavior (translation) of materials, equipment, workers and so on.

The “Rotate behavior” is set to cause the whole or a part of an object (e.g. equipment) to rotate at that position so that the object changes direction.

The “Rotate behavior” can be defined according to the object as follows. Basically, the “Rotate behavior” can be defined based on a surface of rotation, a rotation start point and a rotation end point. An object is automatically defined when the surface of rotation thereof is limited. For example, a tower crane rotates only in the direction of the horizontal surface (xy plane), and the arm of a backhoe rotates only in the up-down direction about the vertical surface of the arm. In the case of a tower crane, a bulldozer, a backhoe or so on, the end point may not be separately defined, font a point where construction must be carried out can be defined as the end point.

In the behavior library storage 120, the above-described behaviors are defined in advance according to the objects. The scheme of storing behaviors according to the objects is preferable. However, it is possible to use a matching table in which common behaviors are matched according to the objects, since the common behaviors may be used.

The object behavior value input section 130 receives behavior values for an instance which is one object from among those stored and modeled on the simulation system.

The behavior values of the instance include a position where a behavior starts, a position where the behavior ends, the number of repetitions of the behavior, the speed, of the behavior, a 3D directional value of the behavior and so on. For example, it is possible to input a point where a truck starts loaded with materials, a point where the materials are unloaded, the number of movements, or so on. As for equipment such as a tower crane, values such as the direction and speed of rotation can be additionally inputted. As for a material such as a wall, values such as the speed at which the wall grows and the direction in which the wall grows can be inputted.

The behavior values of the instance can be inputted by a variety of techniques. The simulation system according to the invention outputs the behavior values on the display 150 such as a computer display. For example, the behavior values can be inputted on a behavior displaying part 152 which displays behaviors of objects. A position, can be inputted based on xy coordinates, and a 3D direction can be set using x, y and z coordinates based on the position where the instance is placed.

Furthermore, the behavior values can be set in an intuitive way using, for example, an arrow at a main displaying part 154 which displays an instance and behaviors of the instance. It is possible to create an instance by dragging one object from among the objects displayed on an object displaying part 151 and dropping the dragged object onto the main displaying part 154. In this case, for example, the start point and the end point of a passage along which the added instance moves can be set.

When the start point and the end point of the movement are set, the passage of movement is set in consideration of the positions of other instances on the passage. The passage of movement is set by applying various types of algorithm which are widely used in the field of computing.

When behavior values are inputted for all instances which are subjected to simulation, simulation for the entire schedule is possible. As set forth above, the invention provides an object-based simulation system which completes an entire simulation by receiving behaviors defined according to objects and detailed data about the behaviors.

When definition of each object subjected to simulation is completed, the modeling section 140 executes modeling based on the object data, the behaviors and the behavior values stored in the library storage 110 in order to express the objects in graphics. When the modeling of the objects is completed, corresponding content is transmitted to the display 150, so that a simulation screen is displayed.

Furthermore, the invention may also include an alarming section 160. When two or more modeled objects interfere with each other during the simulation, the alarming section 160 indicates the interfering objects and interfering points. The alarming section 160 monitors in real time whether or not objects interfere with each other by receiving data from the modeling section 140, and when interference occurs, displays information about interfering objects, a point, time and so on via the display 150.

Hereinafter, a detailed description of the invention will be given by way of example with respect to a simulation window which is displayed via the display 150.

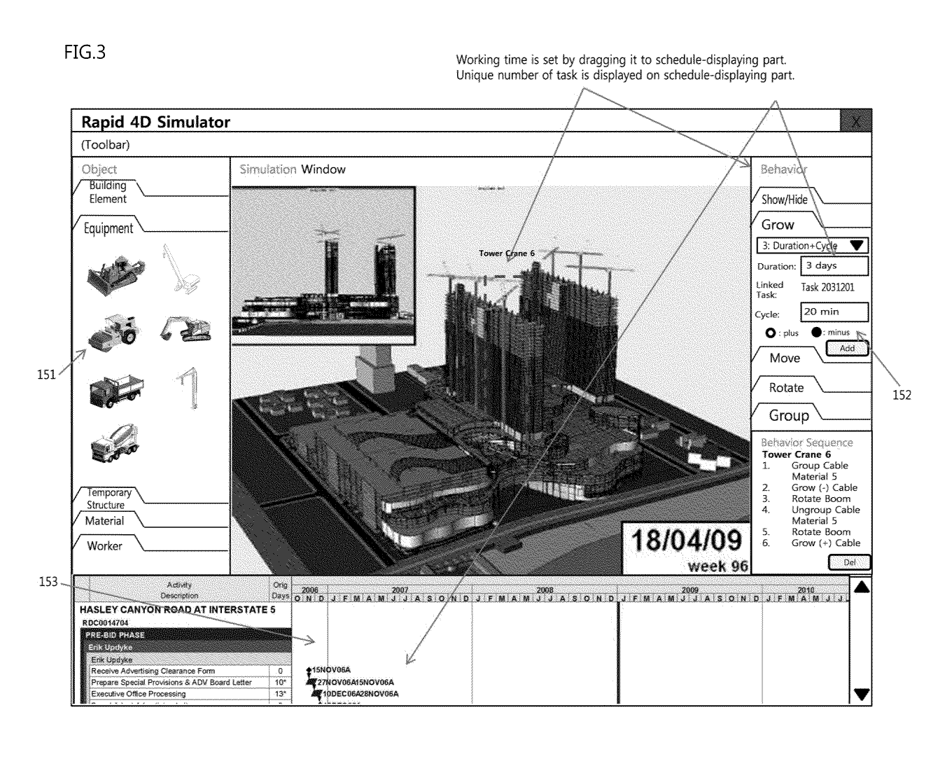

FIG. 3 shows an example of a simulation screen according to the invention.

The display 150 includes the object displaying part 151 which displays icons of objects according to types, the behavior displaying part 152 which displays behaviors of the objects, a schedule displaying part 153 which displays schedules linked to the objects, and the main displaying part 154 on which a 4D construction schedule is simulated.

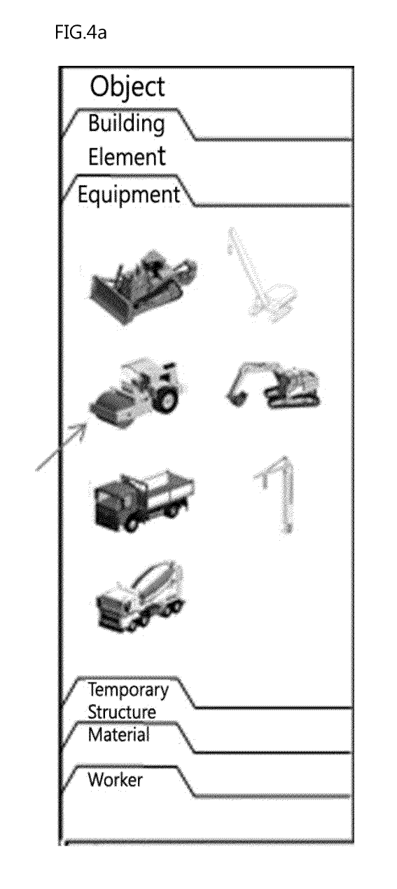

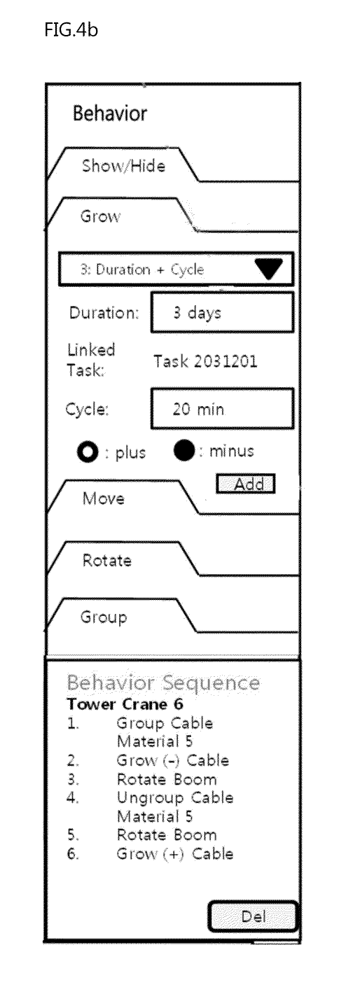

FIG. 4A is an enlargement of the object displaying part 151 which is shown in the left part of FIG. 3. FIG. 4A shows building element, equipment, temporary structure, material and worker tabs. In FIG. 4A, the equipment tab is selected and objects of the equipment group are displayed as icons.

An object displayed on the object, displaying part 151 can be dragged and dropped onto the main displaying part 154 so that it is placed on the simulation. The object which is dragged and dropped on the main displaying part 154 forms an instance which is expressed in the simulation. For example, when a tower crane displayed on the object displaying part 151 is placed on the main displaying part 154, it becomes an instance which operates in the actual, simulation (the dotted line area in the main displaying part 154 in FIG. 3). In other words, the instance means an object that operates in the actual simulation.

As for the object (instance) placed on the main displaying part 154 as described above, behaviors that can be executed are determined in advance based on a matching table of the instance behavior valise input section 130. The behavior displaying part 152 is positioned at the right part of FIG. 3, and the corresponding screen is enlarged in FIG. 4B.

The object selected in FIG. 3 is a tower crane, and the behavior displaying part 152 displays behaviors, such as Show/Ride, Grow, Translate, Rotate and other behaviors, which the tower crane can execute. In this case, a Grow tab is opened. Referring to FIG. 4B, input values for defining behaviors of the selected object can be inputted. The duration of the grow behavior is 3 days, the cycle of the growth is 20 minutes, and the direction of the Grow behavior is selected as minus. The term minus indicates that the tower crane changes such that it becomes lower.

The behaviors of the selected object can be sequentially or repeatedly defined. For example, when equipment (a truck) is moving, a repetition time and a number of repetitions can be set. In the case of the Translate behavior, the start point and the end point can be set via the drag and drop function, or coordinate values can be directly inputted into the behavior displaying part 152. In the case of an object that is required to move throughout its entire working time, a working time and a number of repetitions can be set. Otherwise, the object can be set such that it moves at a predetermined speed throughout the entire working time.

Furthermore, the “entire working time” of one object that is used in time setting can be determined in association with the tasks of the schedule. The “entire working time” can also be defined as “a start date and a period” or “a start date and an end date.”

An input value setting part 132 of the instance behavior value input section 130 can be realized in a variety of forms. While numerical behavior values for the behaviors of objects can be summarily inputted in the form, of a table, it is most convenient to input them via a behavior displaying part in the display 150, as shown in FIG. 3 and FIG. 4B. In other words, the behavior displaying part servos as an interface of the input value setting part 132.

Referring to FIG. 4B, the sequence of the behaviors of the selected object (Tower Crane 6) are displayed on the bottom of the behavior displaying part 152. To aid in the understanding of the invention, detailed descriptions will be given following the sequence of the behaviors.

1. Tower Crane 6 forms a group with Cable Material 5, a material. Grouping is a behavior: When two or more objects are grouped together, they act like one object. That is, unless subsequent behaviors are defined. Cable Material 5 moves or rotates together with Tower Crane 6 before being ungrouped.

When one or more objects are added to one group, an input values of a behavior of an object of the group is commonly set to the added objects.

2. Cable Material 5 grows negative. That is, the amount of Cable Material 5 decreases.

3. The boom of Tower Crane 6 rotates. At this time, Cable Material 5 in the same group rotates along with the boom of Tower Crane 6.

4. Cable Material 5 is ungrouped. Through this behavior, Cable Material 5 is loaded on a corresponding position.

5. The boom of Tower Crane 6 rotates again.

6. After rotation, the amount of Cable Material 5 loaded on the corresponding position increases.

When this process is set to each object, the construction schedule simulation is completed. For example, when the behaviors of Tower Crane 6 are set as above, the behaviors of Tower Crane 6 are registered in the schedule. Referring to FIG. 3, when a behavior of Tower Crane 6 is dragged to the schedule displaying part 153 on the bottom, the schedule displaying part 153 shows a screen on which the unique number of the task and the corresponding content are displayed. The schedule displaying part 153 displays the schedule of each, object with times based on an input value about a behaviors of one object.

Otherwise, it is possible to set a schedule first and then connect each object which is used in that schedule. The schedule can be inputted via a schedule management system which is provided in advance depending on a construction schedule plan.

A part of the schedule is completed by selecting the object and defining the behaviors of the selected object (instance). When the behaviors of the whole objects are defined, the entire schedule is completed. The completed schedule is stored in a schedule storage 170, as shown in FIG. 1.

After the entire schedule is completed, it is possible to make up a simulation on the construction schedule. It is possible to inspect whether or not a problem, such as interference between objects, will occur, and previously review the arrangement of equipment and the sequence of the schedule which are required for effectively carrying oat the construction schedule. A user of the fast 4D construction schedule simulation system based on object behaviors 100 according to the invention can easily understand the entire construction schedule by a simple work of inputting behaviors of objects.

The foregoing descriptions of specific exemplary embodiments of the present invention nave been presented with respect to the certain embodiments and drawings. They are not intended to be exhaustive or to limit the invention to the precise forms disclosed, and obviously many modifications and variations are possible for a person having ordinary skill in the art in light of the above teachings. It is intended that such modifications and variations fall within the scope of the invention, defined by the Claims appended hereto and their equivalents.

What is claimed is:

1. A fast 4-dimensional construction schedule simulation system based on object behaviors, comprising:
an object library storage for storing object data;
a behavior library storage for storing behaviors according to object, types of the object data;
an instance behavior value input section for inputting behavior values of an instance created from the object data to be modeled;
a modeling section for modelling the instance using the object data, the behaviors and the behavior values; and
a display for displaying a behavior of the modeled instance.

2. The fast 4-dimensional construction schedule simulation system, according to claim 1, wherein object data stored in the object library storage are divided into worker group, equipment group, temporary structure group, material group, building element group, foundation group and miscellaneous groups, wherein
the worker group includes workers, the equipment group includes a tower crane, a bulldozer, a truck, a backhoe and a borer, the temporary structure group includes scaffolding, a mold, a wheel washer, a temporary office and a fence, the material group includes reinforcing rods, earth, cement, wood and concrete beams, the building element group includes walls, stairs, beams, columns, doors, windows and building equipment, the foundation group includes a foundation, and the miscellaneous group includes furniture and sanitary equipment.

3. The fast 4-dimensional construction schedule simulation system according to claim 1, wherein behaviors stored in the behavior library storage include at least one behavior selected from the group consisting of show, hide, translate, rotate, group and grow.

4. The fast 4-dimensional construction schedule simulation system according to claim 2, wherein behaviors of the objects are defined as in a following table.

| Object group | Object Examples | Object Behaviors |
|---|---|---|
| Worker | Worker | Show, Hide, Translate, |
| | | Rotate, Group |
| Equipment | Tower crane | Show, Hide, Divide, Grow |
| | | (Boom, Mast, Cable), Rotate |
| | | (only boom post), Group |
| | Bulldozer, Truck | Show, Hide, Translate, |
| | | Rotate, Group |
| | Backhoe | Show, Hide, Translate, |
| | | Rotate (only upper part or |
| | | arm part is rotatable, or |
| | | entire parts are rotatable), |
| | | Group |
| | Borer | Show, Hide, Translate, |
| | | Rotate, Group |
| Temporary | Scaffolding, Mold, | Show, Hide, Translate, |
| structure | Wheel washer, | Rotate, Group, Grow, Divide |
| | Temporary office, | |
| | Fence | |
| Material | Reinforcing rod, | Show, Hide, Translate, |
| | Earth, Cement, | Rotate, Group, Grow, Divide |
| | Wood, Concrete | |
| | beam | |
| Foundation | Foundation | Grow |
| Building | Wall, stair, Beam, | Show, Hide, Translate, |
| element | Column, Door, | Group, Rotate, |
| | Window, etc. | Grow, Divide |
| Miscellaneous | Furniture, | Show, Hide, Translate, |
| | Sanitary equipment | Group, Rotate |

5. The fast 4-dimensional construction schedule simulation system according to claim 1, wherein the behavior values of the instance includes at least one value selected from the group consisting of a position where a behavior starts, a position where the behavior ends, a number of repetitions of the behavior, a pace of the behavior and a 3-dimensional directional value of the behavior.

6. The fast 4-dimensional construction schedule simulation system according to claim 1, wherein the display comprises:
an object displaying part for displaying icons of the objects according to the types;
a behavior displaying part for displaying behaviors of the objects;
a schedule displaying part for displaying schedules linked to the objects; and
a main displaying part for displaying a simulated 4-dimensional construction schedule.

7. The fast 4-dimensional construction schedule simulation system according to claim 6, wherein the object behavior input section receives the behavior values for the instance via the behavior displaying part.

8. The fast 4-dimensional construction schedule simulation system according to claim 6, wherein an instance to be simulated is added by dragging one object from among the objects displayed on the object displaying part and dropping the one object onto the main displaying part, and the main displaying part or the behavior displaying part sets behavior values of the added instance.

9. The fast 4-dimensional construction schedule simulation system according to claim 6, wherein the schedule displaying part displays the schedules of the instances with times based on the behavior values of the instances.

10. The fast 4-dimensional construction schedule simulation system according to claim 8, wherein, when at least one instance that is added is set to a group, the behavior values of the instances belonging to the group are commonly set based on one behavior value.

11. The fast 4-dimensional construction schedule simulation system according to claim 1, further comprising an alarming section for indicating conflicting instances and locations when two or more modeled instances interfere with each other during simulation.
